(19) United States
(12) Patent Application Publication
(10) Pub. No.: US 2020/0369306 A1
(43) Pub. Date: Nov. 26, 2020

(54) HAND TRUCK

(71) Applicant: MYW LLC, Acworth, GA (US)

(72) Inventor: Stephen Davis West, JR., Acworth, GA (US)

(21) Appl. No.: 16/416,385

(22) Filed: May 20, 2019

(51) Int. Cl. B62B 1/00; B62B 3/06; B62B 3/02; B62B 1/12

(52) U.S. Cl. CPC B62B 1/002; B62B 3/0606; B62B 2206/006; B62B 1/12; B62B 2205/12; B62B 3/022

(57) ABSTRACT

A hand truck that is reconfigurable between one or more hand truck operational configurations and a hand truck stowed configuration is provided. The hand truck comprises a primary wheel assembly that is aligned in a primary wheel operational configuration in the multiple hand truck operational configurations and a primary wheel stowed configuration in the hand truck stowed configuration.

### TECHNICAL FIELD

The present disclosure is directed to hand trucks and, more particularly, to hand trucks for use in outdoor environments and/or reconfigurable between a stowed configuration and one or more operational configurations.

### BACKGROUND

Transporting heavy folding tents and canopies across soft sand can prove challenging for beach goers, with the small wheels of traditional tent carrying bags sinking into the sand. Transporting other types of recreational equipment across sand, grass, gravel and dirt also can be challenging with the wheels of conventional manually operated carriers being ill-equipped to move across loosely packed material under loads without sinking into the surface materials. Furthermore, conventional equipment carriers often are poorly suited for compact storage and transport when not being used to haul cargo.

Consequently, there is a need for hand trucks that can potentially address one or more of these and other challenges.

### SUMMARY

The present disclosure encompasses hand trucks that can be used in outdoor environments on uneven and/or loosely compacted surfaces for transporting cargo. The present disclosure also encompasses hand trucks that can be reconfigurable between a hand truck stowed configuration and one or more hand truck operational configurations.

The present disclosure encompasses a hand truck comprising: a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end; a handle connected to the load carrier frame and aligned proximal to the upper end of the load carrier frame and distal to the base end of the lower carrier frame; a primary wheel assembly detachably connected to the load carrier frame, wherein the primary wheel assembly comprises primary wheel axle and a plurality of primary wheels rotatably mounted on the primary wheel axle, wherein the primary wheel assembly is reconfigurable between a primary wheel deployed configuration and a primary wheel stowed configuration, wherein the primary wheel assembly is connected to the primary wheel bracket and configured to rotatably support the load carrier frame in the primary wheel deployed configuration, wherein the plurality of primary wheels are aligned distal to the load carrier bed in the primary wheel deployed configuration, wherein the primary wheel assembly is connected to the load carrier bed in the primary wheel stowed configuration, and wherein the plurality of wheels are aligned proximal to the load carrier bed in the primary wheel stowed configuration; a secondary wheel assembly movably connected to the load carrier frame, wherein the secondary wheel assembly comprises a secondary wheel bracket and a plurality of secondary wheels rotatably mounted on the secondary wheel bracket, wherein the secondary wheel assembly is reconfigurable between a secondary wheel deployed configuration and a secondary wheel stowed configuration, wherein the plurality of secondary wheels are aligned distal to the load carrier bed in the secondary wheel deployed configuration, and wherein the plurality of secondary wheels are aligned proximal to the load carrier bed in the secondary wheel stowed configuration; wherein the hand truck is reconfigurable between a first hand truck operational configuration, a second hand truck operational configuration, and a hand truck stowed configuration, wherein the hand truck is configured to roll and to support cargo in the first hand truck operational configuration and the second hand truck operational configuration, wherein the hand truck is configured for unloaded storage and transport in the hand truck stowed configuration, wherein the primary wheel assembly is in the primary wheel deployed configuration and the secondary wheel assembly is in the secondary wheel stowed configuration in the first hand truck operational configuration, wherein the primary wheel assembly is in the primary wheel deployed configuration and the secondary wheel assembly is in the secondary wheel deployed configuration in the second hand truck operational configuration, and wherein the primary wheel assembly is in the primary wheel stowed configuration and the secondary wheel assembly is in the secondary wheel stowed configuration in the hand truck stowed configuration.

In one aspect, the hand truck can further comprise a primary wheel assembly receiver mounted on the primary wheel bracket, wherein the primary wheel assembly receiver engages the primary wheel axle of the primary wheel assembly in the primary wheel deployed configuration, and wherein the primary wheel assembly is disengaged from the primary wheel assembly receiver in the primary wheel stowed configuration. In another aspect, the hand truck can further comprise a primary wheel fastener connected to the load carrier bed, wherein the primary wheel fastener connects the primary wheel assembly to the load carrier bed in the primary wheel stowed configuration. In a further aspect, the primary wheel fastener is a strap. In still another aspect, the hand truck can further comprise a base plate mounted to the load carrier frame proximal to the base end and distal to the upper end of the load carrier frame, and wherein the base plate is configured to receive cargo loaded on the hand truck. In still a further aspect, the base plate can comprise a back plate connected to the load carrier bed, a base plate hinge mounted to the back plate, and a foot plate connected to the base plate hinge, wherein the foot plate is pivotal on the base plate hinge between a base plate deployed configuration and a base plate stowed configuration, wherein the foot plate is aligned distal to the back plate in the base plate deployed configuration, and wherein the foot plate is aligned proximal to the back plate in the base plate stowed configuration. In another aspect, the foot plate can be in the base plate stowed configuration in the hand truck stowed configuration. In yet a further aspect, each primary wheel of the plurality of primary wheels can exhibit a width that is in a range of about 50% to about 120% of the diameter of the primary wheel. In yet another aspect, the hand truck can further comprise a cargo rack movably mounted to the load carrier frame, and wherein the cargo rack comprises a cargo rack outward side and a cargo rack base side. In still a further aspect, the cargo rack can be movable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration. In another aspect, the hand truck can be reconfigurable between the first hand truck operational configuration, the second hand truck operational configuration, a third hand truck operational configuration, a fourth hand truck operational configuration, and the hand truck stowed configuration, wherein the hand truck is configured to roll and support cargo in the third hand truck operational configuration and the fourth hand truck operational configuration, wherein the primary wheel assembly is in the primary wheel deployed configuration in the third hand truck operational configuration, wherein the secondary wheel assembly is in the secondary wheel stowed configuration in the third hand truck operational configuration, wherein the cargo rack is in the cargo rack deployed configuration in the third hand truck operational configuration, wherein the primary wheel assembly is in the primary wheel deployed configuration in the fourth hand truck operational configuration, wherein the secondary wheel assembly is in the secondary wheel deployed configuration in the fourth hand truck operational configuration, and wherein the cargo rack is in the cargo rack deployed configuration in the fourth hand truck operational configuration.

The present disclosure also encompasses a hand truck comprising: a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end; a handle connected to the load carrier frame and aligned proximal to the upper end of the load carrier frame and distal to the base end of the lower carrier frame; a cargo rack pivotally mounted to the load carrier frame, wherein the cargo rack comprises a cargo rack outward side and a cargo rack base side, wherein the cargo rack is pivotable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration; a primary wheel assembly detachably connected to the load carrier frame, wherein the primary wheel assembly comprises primary wheel axle and a plurality of primary wheels rotatably mounted on the primary wheel axle, wherein the primary wheel assembly is movable between a primary wheel deployed configuration and a primary wheel stowed configuration, and wherein the plurality of primary wheels are configured to roll and to support the load carrier frame in the primary wheel deployed configuration; a secondary wheel assembly pivotally connected to the load carrier frame, wherein the secondary wheel assembly comprises a secondary wheel bracket and a plurality of secondary wheels rotatably mounted to the secondary wheel bracket, wherein the secondary wheel assembly is pivotable between a secondary wheel deployed configuration and a secondary wheel stowed configuration, and wherein the plurality of secondary wheels are configured to roll and to support the load carrier frame in the secondary wheel deployed configuration; wherein the hand truck is reconfigurable between a first hand truck operational configuration, a second hand truck operational configuration, a third hand truck operational configuration, a fourth hand truck operational configuration, and a hand truck stowed configuration, wherein the hand truck is configured to roll and to support cargo in the first hand truck operational configuration, the second hand truck operational configuration, the third hand truck operational configuration, and the fourth hand truck operational configuration, wherein the hand truck is configured for unloaded storage and transport of the hand truck in the hand truck stowed configuration, wherein the primary wheel assembly is in the primary wheel deployed configuration in the first hand truck operational configuration, the secondary wheel assembly is in the secondary wheel stowed configuration in the first hand truck operational configuration, the cargo rack is in the cargo rack stowed configuration in the first hand truck operational configuration, wherein the primary wheel assembly is in the primary wheel deployed configuration in the second hand truck operational configuration, the secondary wheel assembly is in the secondary wheel deployed configuration in the second hand truck operational configuration, the cargo rack is in the cargo rack stowed configuration in the second hand truck operational configuration, wherein the primary wheel assembly is in the primary wheel deployed configuration in the third hand truck operational configuration, the secondary wheel assembly is in the secondary wheel stowed configuration in the third hand truck operational configuration, the cargo rack is in the cargo rack deployed configuration in the third hand truck operational configuration, wherein the primary wheel assembly is in the primary wheel deployed configuration in the fourth hand truck operational configuration, the secondary wheel assembly is in the secondary wheel deployed configuration in the fourth hand truck operational configuration, the cargo rack is in the cargo rack deployed configuration in the fourth hand truck operational configuration, wherein the primary wheel assembly is in the primary wheel stowed configuration in the hand truck stowed configuration, the secondary wheel assembly is in the secondary wheel stowed configuration in the hand truck stowed configuration, and the cargo rack is in the cargo rack stowed configuration in the hand truck stowed configuration.

In one aspect, the hand truck can further comprise a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, and wherein the foot plate is aligned proximal to the back plate in the base plate stowed configuration. In another aspect, the foot plate can be in the base plate stowed configuration in the hand truck stowed configuration. In a further aspect, each primary wheel of the plurality of primary wheels can exhibit a width that is in range of about 50% to about 120% of the diameter of the primary wheel. In yet another aspect, the hand truck can further comprise a primary wheel fastener connected to the load carrier bed, wherein the primary wheel fastener connects the primary wheel assembly to the load carrier bed in the primary wheel stowed configuration. In still another aspect, the primary wheel fastener can be a strap. In a further aspect, the cargo rack can comprise a first cargo rack arm, an opposing second cargo rack arm, and a cargo rack cross bar extending between and connected to the first cargo rack arm and the second cargo rack arm.

The present disclosure also encompasses a hand truck comprising: a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end; a handle connected to the load carrier frame and aligned proximal to the upper end of the load carrier frame and distal to the base end of the lower carrier frame; a cargo rack pivotally mounted to the load carrier frame, wherein the cargo rack comprises a cargo rack outward side and a cargo rack base side, wherein the cargo rack is pivotable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration, wherein the cargo rack further comprises a first cargo rack arm, an opposing second cargo rack arm, and a cargo rack cross bar extending between and connected to the first cargo rack arm and the second cargo rack arm; a primary wheel assembly detachably connected to the load carrier frame, wherein the primary wheel assembly comprises primary wheel axle and a plurality of primary wheels rotatably mounted on the primary wheel axle, wherein the primary wheel assembly is movable between a primary wheel deployed configuration and a primary wheel stowed configuration, wherein the plurality of primary wheels are configured to roll and to support the load carrier frame in the primary wheel deployed configuration, wherein the primary wheel assembly is connected to the primary wheel bracket in the primary wheel deployed configuration and disconnected from the primary wheel bracket in the primary wheel stowed configuration, wherein each primary wheel of the plurality of primary wheels exhibits a width that is in a range of 50% to 120% of a diameter of the primary wheel; a secondary wheel assembly pivotally connected to the load carrier frame, wherein the secondary wheel assembly comprises a secondary wheel bracket and a plurality of secondary wheels rotatably mounted to the secondary wheel bracket, wherein the secondary wheel assembly is pivotable between a secondary wheel deployed configuration and a secondary wheel stowed configuration, and wherein the plurality of secondary wheels are configured to roll and to support the load carrier frame in the secondary wheel deployed configuration; wherein the hand truck is reconfigurable between a first hand truck operational configuration, a second hand truck operational configuration, a third hand truck operational configuration, a fourth hand truck operational configuration, and a hand truck stowed configuration, wherein the hand truck is configured to roll and to support cargo in the first hand truck operational configuration, the second hand truck operational configuration, the third hand truck operational configuration, and the fourth hand truck operational configuration, wherein the hand truck is configured for unloaded storage and transport of the hand truck in the hand truck stowed configuration, wherein the primary wheel assembly is in the primary wheel deployed configuration in the first hand truck operational configuration, the secondary wheel assembly is in the secondary wheel stowed configuration in the first hand truck operational configuration, the cargo rack is in the cargo rack stowed configuration in the first hand truck operational configuration, wherein the primary wheel assembly is in the primary wheel deployed configuration in the second hand truck operational configuration, the secondary wheel assembly is in the secondary wheel deployed configuration in the second hand truck operational configuration, the cargo rack is in the cargo rack stowed configuration in the second hand truck operational configuration, wherein the primary wheel assembly is in the primary wheel deployed configuration in the third hand truck operational configuration, the secondary wheel assembly is in the secondary wheel stowed configuration in the third hand truck operational configuration, the cargo rack is in the cargo rack deployed configuration in the third hand truck operational configuration, wherein the primary wheel assembly is in the primary wheel deployed configuration in the fourth hand truck operational configuration, the secondary wheel assembly is in the secondary wheel deployed configuration in the fourth hand truck operational configuration, the cargo rack is in the cargo rack deployed configuration in the fourth hand truck operational configuration, wherein the primary wheel assembly is in the primary wheel stowed configuration in the hand truck stowed configuration, the secondary wheel assembly is in the secondary wheel stowed configuration in the hand truck stowed configuration, and the cargo rack is in the cargo rack stowed configuration in the hand truck stowed configuration.

In one aspect, the hand truck can further comprise a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, and wherein the foot plate is aligned proximal to the back plate in the base plate stowed configuration.

The present disclosure also encompasses a hand truck comprising: a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end; a handle connected to the load carrier frame and aligned proximal to the upper end of the load carrier frame and distal to the base end of the lower carrier frame; a primary wheel assembly detachably connected to the load carrier frame, wherein the primary wheel assembly comprises primary wheel axle and a plurality of primary wheels rotatably mounted on the primary wheel axle, wherein each primary wheel of the plurality of primary wheels exhibits a width in a range of about 50% to about 120% of the diameter of the primary wheel, wherein the primary wheel assembly is reconfigurable between a primary wheel deployed configuration and a primary wheel stowed configuration, wherein the primary wheel assembly is connected to the primary wheel bracket and configured to rotatably support the load carrier frame in the primary wheel deployed configuration, wherein the plurality of primary wheels are aligned distal to the load carrier bed in the primary wheel deployed configuration, wherein the primary wheel assembly is connected to the load carrier bed in the primary wheel stowed configuration, and wherein the plurality of wheels are aligned proximal to the load carrier bed in the primary wheel stowed configuration; wherein the hand truck is reconfigurable between a hand truck operational configuration and a hand truck stowed configuration, wherein the hand truck is configured to roll and to support cargo in the hand truck operational configuration, wherein the hand truck is configured for unloaded storage and transport in the hand truck stowed configuration, wherein the primary wheel assembly is in the primary wheel deployed configuration in the hand truck operational configuration, and wherein the primary wheel assembly is in the primary wheel stowed configuration in the hand truck stowed configuration.

In one aspect, the hand truck can further comprise a primary wheel assembly receiver mounted to the primary wheel bracket, wherein the primary wheel assembly receiver engages the primary wheel assembly in the primary wheel deployed configuration, and wherein the primary wheel assembly is disengaged from the primary wheel assembly receiver in the primary wheel stowed configuration. In another aspect, the hand truck can further comprise a cargo rack movably mounted to the load carrier frame, and wherein the cargo rack comprises a cargo rack outward side and a cargo rack base side. In a further aspect, the cargo rack can be movable between a cargo rack deployed configuration and a cargo rack stowed configuration, wherein the cargo rack outward side is aligned distal to the load carrier bed in the cargo rack deployed configuration, wherein the cargo rack outward side is aligned proximal to the load carrier bed in the cargo rack stowed configuration, wherein the cargo rack is aligned in the cargo rack stowed configuration in the hand truck stowed configuration. In yet another aspect, the hand truck can further comprise a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, wherein the foot plate is aligned proximal to the back plate in the base plate stowed configuration, and wherein the foot plate is in the base plate stowed configuration in the hand truck stowed configuration.

These and other aspects of the present disclosure are set forth in more detail below and illustrated in the drawings, which are briefly described as follows.

### BRIEF DESCRIPTION OF THE DRAWINGS

FIG. 1 shows a perspective view of a hand truck encompassing aspects of the present disclosure illustrated in a hand truck operational configuration in which the primary wheel assembly is in a primary wheel deployed configuration, the secondary wheel assembly is in a secondary wheel deployed configuration, the base plate is in a base plate deployed configuration, and the cargo rack is in a cargo rack stowed configuration.

FIG. 2 illustrates a side elevation view of the hand truck shown in FIG. 1 disposed on a flat horizontal surface, illustrating the angle of alignment A of the load carrier bed relative to the surface upon which the hand truck stands, and with a basket added to the hand truck.

FIG. 3 illustrates a front perspective view of the hand truck in the hand truck operational configuration shown in FIG. 1.

FIG. 4A illustrates a rear perspective view of the hand truck shown in FIG. 1.

FIG. 4B illustrates a partial rear side perspective view of a portion of the hand truck shown in FIG. 1 and showing the first and second secondary wheel bracket hinges.

FIG. 5 illustrates a side perspective view of the hand truck shown in FIG. 1 in another hand truck operational configuration in which the primary wheel assembly is in the primary wheel deployed configuration, the secondary wheel assembly is in a secondary wheel stowed configuration, the base plate is in the base plate deployed configuration, and the cargo rack is in the cargo rack stowed configuration.

FIG. 6A illustrates a front perspective view of the hand truck shown in FIG. 5.

FIG. 6B illustrates a partial side elevation view of a lower portion the hand truck shown in FIG. 5 disposed on a horizontal surface and illustrating the angle of alignment B of the load carrier bed relative to the surface upon which the hand truck stands.

FIG. 7 illustrates a perspective view of the hand truck shown in FIG. 5 in yet another hand truck operational configuration in which the primary wheel assembly is in the primary wheel assembly deployed configuration, the secondary wheel assembly is in the secondary wheel assembly stowed configuration, the base plate is in the base plate deployed configuration, and the cargo rack is in the cargo rack deployed configuration.

FIG. 8A is another perspective view of the hand truck in the hand truck operational configuration shown in FIG. 5 with cargo loaded on the base plate and secured to the load carrier bed, with the cargo illustrated as a tent folded and stowed in a tent carrying bag.

FIG. 8B illustrates a perspective view of the hand truck in the hand truck operational configuration shown in FIG. 1 with cargo loaded on the base plate and secured to the load carrier bed.

FIG. 9A illustrates a perspective view of the hand truck in the hand truck operational configuration shown in FIG. 7 with cargo loaded on both the load carrier bed and the cargo rack, and with cargo loaded on the cargo rack in the form of a plurality of folding chairs.

FIG. 9B illustrates a perspective view of the hand truck shown in FIG. 9A in still another hand truck operational configuration in which the primary wheel assembly is in the primary wheel assembly deployed configuration, the secondary wheel assembly is in the secondary wheel assembly deployed configuration, the base plate is in the base plate deployed configuration, and the cargo rack is in the cargo rack deployed configuration.

FIG. 10A illustrates a partial perspective view of a portion of the hand truck shown in FIG. 5 with the hand truck aligned with the load carrier bed lying on a flat surface and the primary wheel bracket and the primary wheel assembly aligned there above.

FIG. 10B illustrates another partial perspective view of a portion of the hand truck shown in FIG. 10A with the hand truck aligned with the load carrier bed lying on a flat surface and the primary wheel bracket and the primary wheel assembly aligned there above.

FIG. 11 illustrates a side perspective of the hand truck shown in FIG. 1 with the hand truck in a hand truck stowed configuration in which the primary wheel assembly is in a primary wheel assembly stowed configuration, the secondary wheel assembly is in the secondary wheel assembly stowed configuration, the cargo rack is in the cargo rack stowed configuration, and the base plate in a base plate stowed configuration, the hand truck stowed configuration being for storage and/or unloaded transport of the hand truck, with the load carrier bed lying on a flat surface, with the primary wheel assembly detached from the primary wheel bracket and secured to the load carrier frame in the primary wheel stowed configuration.

FIG. 12 illustrates a side elevation view of the hand truck shown in FIG. 11 in the hand truck stowed configuration.

### DETAILED DESCRIPTION

The present disclosure is directed to hand trucks that can be reconfigured between one or more hand truck operational configurations, in which cargo can be loaded on the hand truck and transported thereon, and a non-operational, stowed configuration, which is utilized for storage or unloaded transport of the hand truck. The hand trucks encompassed by the present disclosure can be used to transport cargo loaded thereon over various surfaces, including both flat and uneven surfaces and those that comprise loose material, such as sand, dirt, gravel, rocks, etc. In one aspect, the hand trucks encompassed by the present disclosure can be used to transport on a beach recreational cargo, such as tents, chairs, and sports equipment. The hand trucks encompassed by the present disclosure can be operated on a plurality of primary wheels alone, or a combination of both a plurality of primary and a plurality of secondary wheels.

As used herein, the singular forms of “a,” “an,” and “the” encompass the plural form thereof unless otherwise indicated. As used herein, the phrase “at least one” includes all numbers of one and greater. As used herein, the term “and/or” refers to one or all of the listed elements or a combination of any two or more of the listed elements. As used herein, the term “connected” refers to the direct or indirect linking of one component to another.

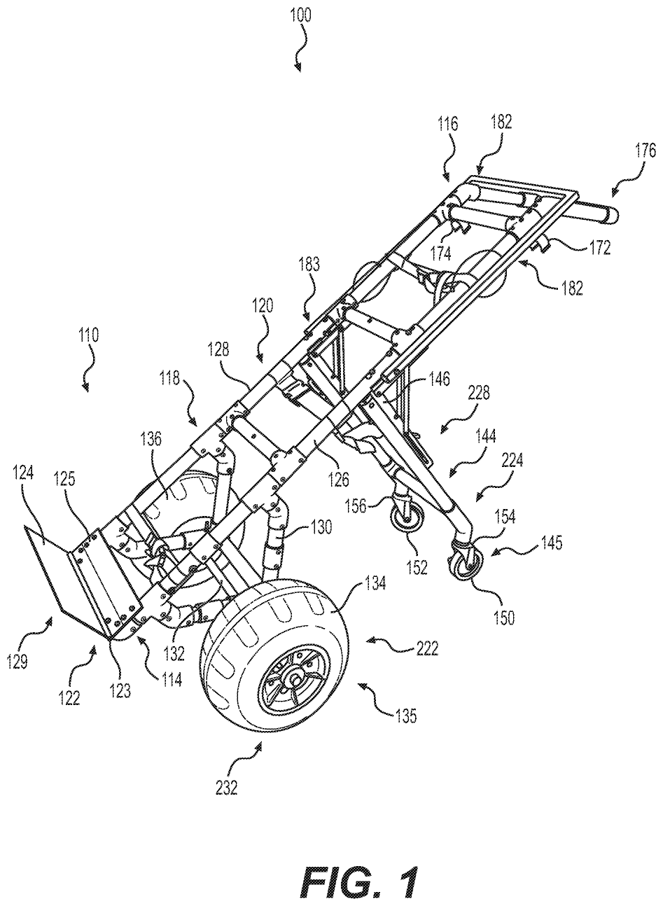

FIGS. 1-12 illustrate various aspects of a hand truck 100 that is encompassed by the present disclosure. FIG. 1 illustrates a hand truck 100 that is reconfigurable into multiple configurations, including four separate hand truck operational configurations and at least one non-operational hand truck stowed configuration. The hand truck 100 is designed to support and transport cargo and be moved and steered by hand. The hand truck 100 comprises a load carrier frame 120 that defines a load carrier bed 118 upon and/or against which cargo can be loaded and secured. The load carrier frame 120 comprises a base end 114 and an upper end 116. The load carrier bed 118 extends between the base end 114 and the upper end 116. Mounted on the load carrier frame 120 proximal to the base end 114 is a base plate 122. Proximal to the upper end 116 of the load carrier frame 120 is a handle 176 that can be used by a user of the hand truck 100 to move and manipulate the hand truck 100.

The load carrier frame 120 comprises a first frame member 126 disposed on one side thereof and extending between the base end 114 and the upper end 116 of the load carrier frame 120. A second frame member 128 is disposed on an opposing side of the load carrier frame 120 and also extends between the base end 114 and the upper end 116 of the load carrier frame 120. The first frame member 126 is connected to the second frame member 128 by a lower cross bar 138, a middle cross bar 140, and an upper cross bar 142. The first frame member 126, the second frame member 128, the lower cross bar 138, the middle cross bar 140, and the upper cross bar 142 can be formed of strong, light weight tubing, made of a metal, such as aluminum or steel, and/or a durable thermoplastic material, such as polyvinyl chloride or chlorinated polyvinyl chloride. Metal tubing can be powder coated for resistance to water, salt, and other environmental components. These members and bars of the load carrier frame 120 are aligned in a generally planar or slightly concave configuration and define the load carrier bed 118, which is configured to receive cargo to be loaded on and transported by the hand truck 100. The load carrier frame 120 also comprises a primary wheel bracket 130 aligned proximal to the base end 114 of the load carrier frame 120. The primary wheel bracket 130 extends rearward from the back of the load carrier bed 118.

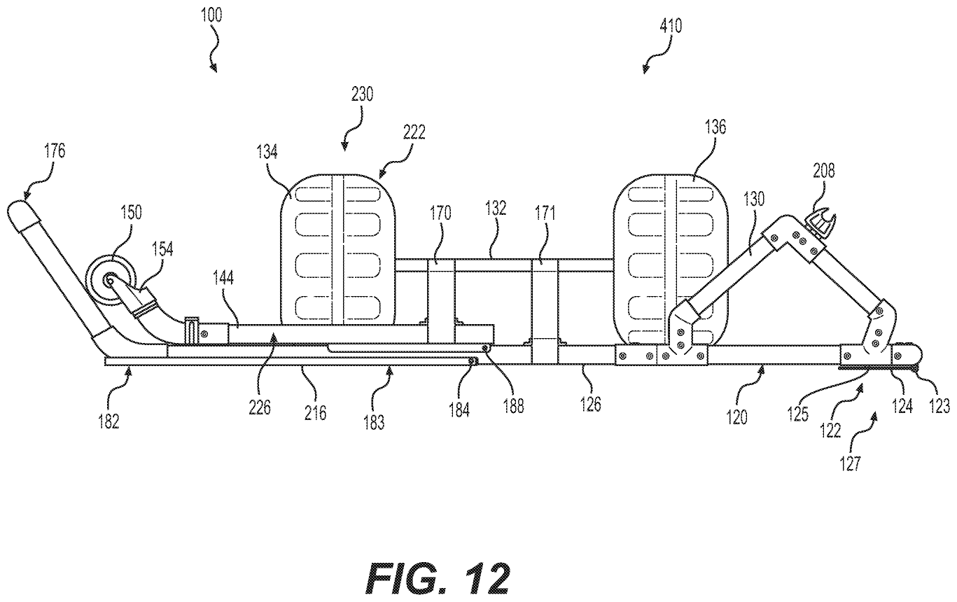

A base plate 122 is mounted to the load carrier frame 120 proximal to the base end 114. The base plate 122 is configured to receive and support cargo thereon. The base plate 122 comprises a foot plate 124 movably connected to a back plate 125 by a base plate hinge 123. The back plate 125 is attached to the load carrier frame 120. The foot plate 124 is configured to pivot on the base plate hinge 123 to and from an open alignment in a base plate deployed configuration 129 to and from a closed alignment in a base plate stowed configuration 127. In the base plate deployed configuration 129, the foot plate 124 is pivoted outward away from the back plate 125 and is distal thereto. In one aspect, the foot plate 124 can form an angle of about 90° with the back plate 125 in a base plate deployed configuration 129. The foot plate 124 is configured to pivot on the foot plate hinge 123 from a base plate deployed configuration 129, as shown in FIG. 1, to a base plate stowed configuration 127, as shown in FIG. 12. In the base plate stowed configuration 127, the foot plate 127 is pivoted on the base plate hinge 123 towards the back plate 125 and is proximal thereto. The base plate 122 is aligned on the load carrier frame 120 so as to provide a platform on which cargo can be disposed with the foot plate 124 and the back plate 125 providing support to the cargo. The base plate 122 can be formed of a metal, such as steel or aluminum, or a durable thermoplastic that can support the weight of cargo to be loaded on the hand truck 100.

The hand truck 100 comprises a plurality of primary wheels 135 and a plurality of secondary wheels 145. The plurality of primary wheels 135 is configured to support the hand truck 100 and roll when the hand truck 100 is pushed. The plurality of primary wheels 135 can comprise a first primary wheel 134 disposed proximal to the first frame member 126 and a second primary wheel 136 disposed proximal to the second frame member 128 of the load carrier frame 120. The first primary wheels 134 is axially aligned with the second primary wheel 136 and a primary wheel axle 132 is operably connected to the first primary wheel 134 and the second primary wheel 136 align, thereby extending along the axis of alignment. The first primary wheel 134 and the secondary primary wheel 136 are rotatably mounted on the primary wheel axle 132, thereby allowing the first and second primary wheels 134 and 136 to rotate about the axis extending lengthwise through the primary wheel axle 132. In another aspect of the present disclosure, the plurality of primary wheels 135 can comprise more than two axially aligned primary wheels.

Each of the first primary wheel 134 and the second primary wheel 136 are configured so as to have a width sufficiently wide to distribute the combined weight of the hand truck 100 and the typical cargo load across surface material across which the hand truck 100 is to be moved, even if the surface material is loosely packed, such as sand, dirt, and gravel, thereby aiding in the avoidance or minimization of the sinking of the hand truck 100 into the surface material. In one aspect, the width of each of the first primary wheel 134 and the secondary primary wheel 136 is in the range of about 50% to about 150% of the diameter of the respective primary wheel. In yet a further aspect, the width of each of the first primary wheel 134 and the secondary primary wheel 136 is in the range of about 50% to about 120% of the diameter of the respective primary wheel.

The primary wheel 134 and the 136 can be a low-pressure pneumatic wheel formed of polyurethane or another lightweight polymeric material. In one aspect, each of the first primary wheel 134 and the secondary primary wheel 136 can exhibit a gauge pressure of less than 105 kPa when fully inflated. In a further aspect, each of the first primary wheel 134 and the secondary primary wheel 136 can exhibit a gauge pressure of less than 90 kPa when fully inflated. In another aspect, each of the first primary wheel 134 and the secondary primary wheel 136 can be foamed filled. In yet another aspect, each of the first primary wheel 134 and the secondary primary wheel 136 can be a solid polymeric wheel.

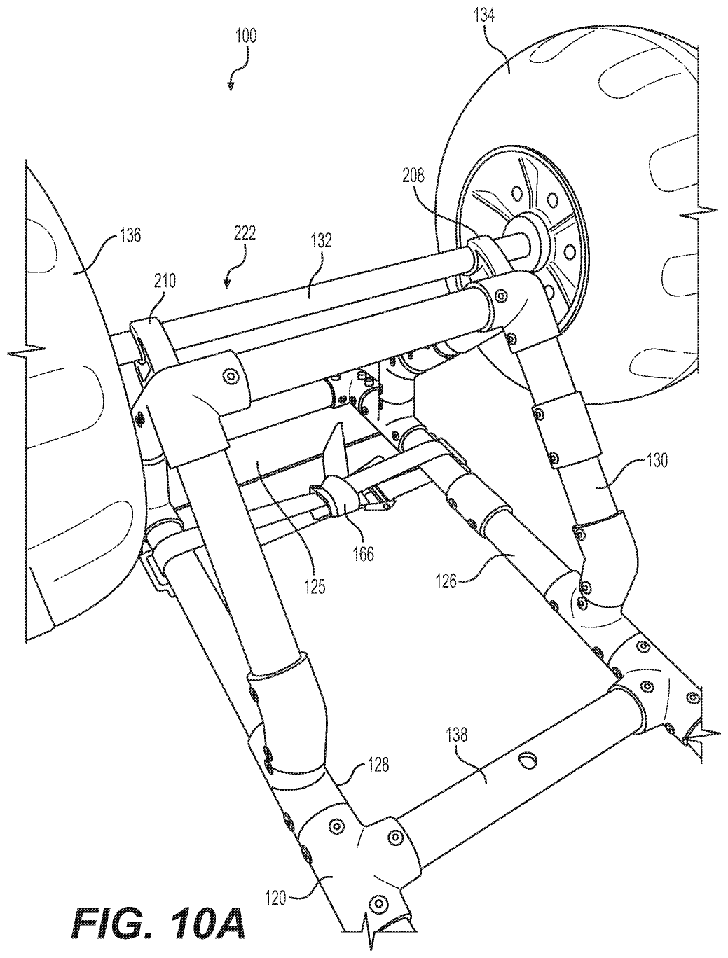

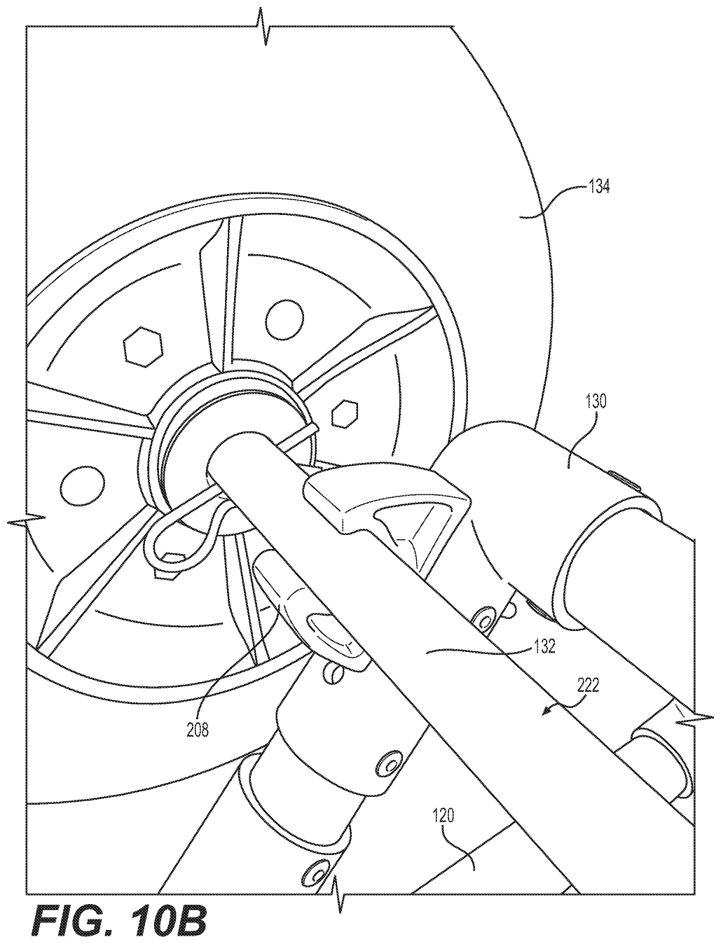

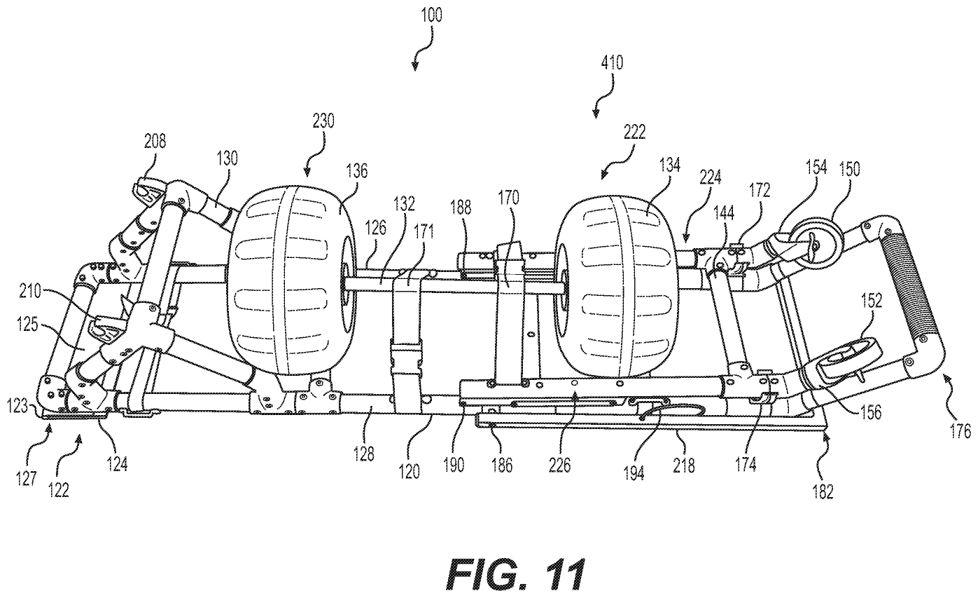

The plurality of primary wheels 135 and the primary wheel axle 132 form a primary wheel assembly 222 that is detachably mounted on the primary wheel bracket 130, which forms a portion of the load carrier frame 120. The primary wheel bracket 130 extends rearward from the load carrier bed 118 and is configured to allow the primary wheel assembly 222 to be mounted to the rear of the load carrier bed 118 and above the base end 114 of the load carrier frame 120. The rearward and upward offset of the primary wheel assembly 130 provided by the primary wheel bracket 130 can assist in the distribution of the center of gravity of the hand truck away from the base end 114 of the load carrier frame 120, thereby allowing for the hand truck 100 to be more easily handled than if the plurality of primary wheels 135 were aligned closer to the load carrier bed 118 and the base end 114 of the load carrier frame 120. The primary wheel axle 132 is detachably connected to primary wheel bracket 130 by a first primary wheel assembly receiver 208 and a second primary wheel assembly receiver 210, both of which are attached or mounted to the primary wheel bracket 130. As shown in FIGS. 10A, 10B and 11, the first primary wheel assembly receiver 208 and the second primary wheel assembly receiver 210 each comprise a pair of curved arms, the ends of which are spaced apart to receive the primary wheel axle 132. The first primary wheel assembly receiver 208 and the second primary wheel assembly receiver 210 can be formed of a resilient elastomeric material that can deform slightly when a pressure is applied thereto, so as to allow the arms of the first primary wheel assembly receiver 208 and the second primary wheel assembly receiver 210 to move and/or deform so to allow for the insertion and removal of the primary wheel axle 132 therefrom, thereby allowing for a quick attachment and detachment of the primary wheel assembly 222 from the load carrier frame 120.

The plurality of secondary wheels 145 comprises a first secondary wheel 150 and a second secondary wheel 152. Each of the first secondary wheel 150 and the second secondary wheel can have a diameter that is smaller than the diameters of the first primary wheel 134 and the second primary wheel 136. The plurality of secondary wheels 145 can be mounted on casters that allow each of the secondary wheels to swivel 360° or more either clockwise or counterclockwise. The first secondary wheel 150 is mounted on a first caster 154 and the second secondary wheel 152 is mounted on a second caster 156. The first secondary wheel 150 can swivel independently of the second secondary wheel 152. The first secondary wheel 150 is operably connected to a first wheel lock 196, and the second secondary wheel 152 is operably connected to a second wheel lock 198. The first wheel lock 196 and the second wheel lock 198 can be operably engaged and disengaged by pressing of the first tab 200 and the second tab 202, respectively.

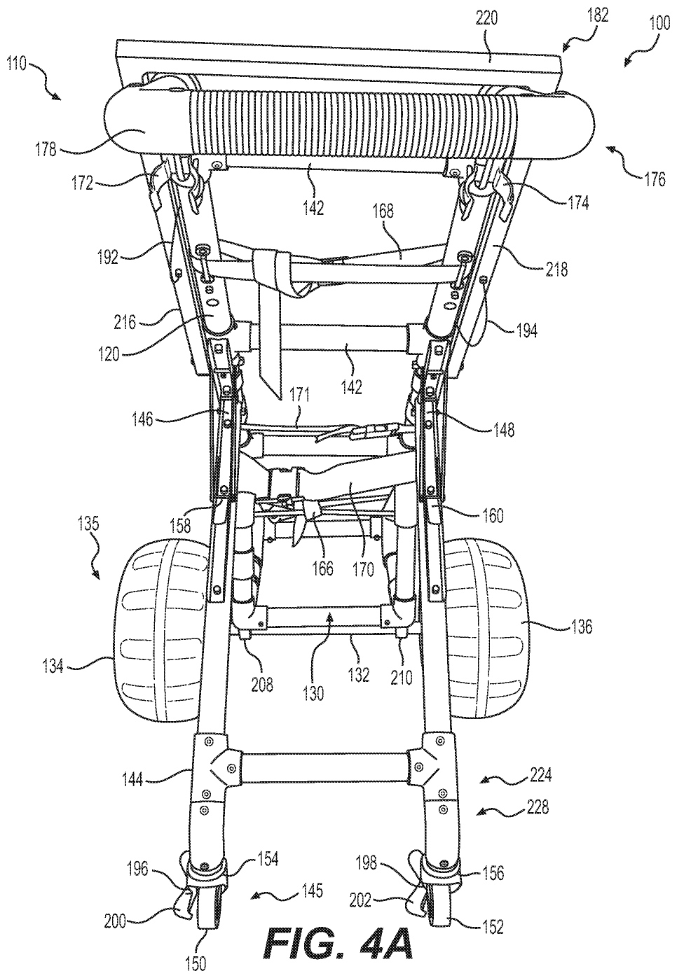

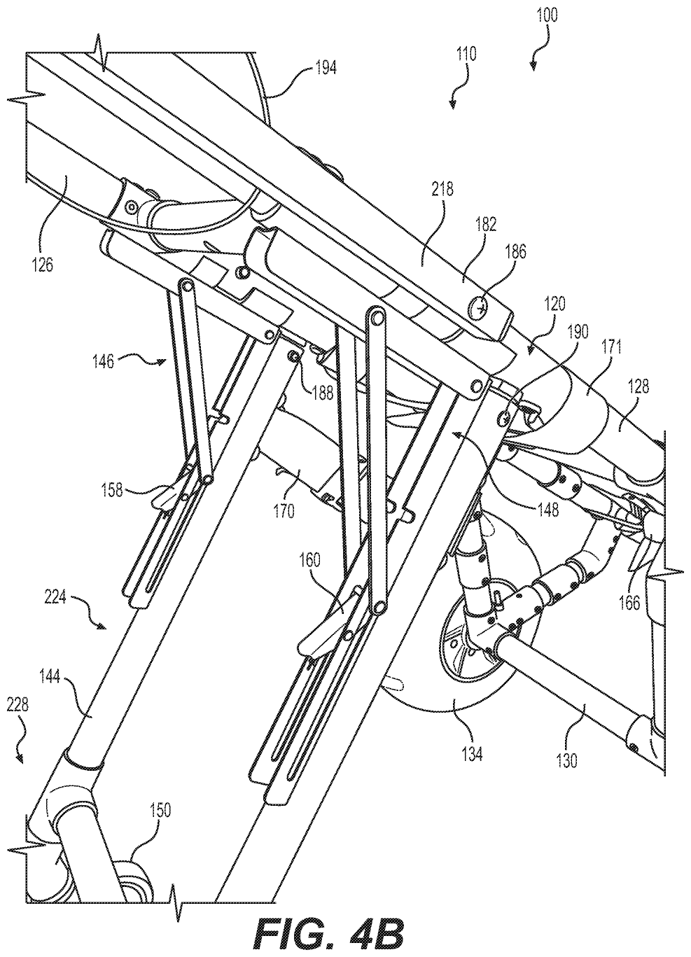

The secondary wheel bracket 144 is pivotally mounted on the load carrier frame 120. As shown in FIGS. 4A and 4B, the secondary wheel bracket 144 comprises a first bracket hinge 146 and a second bracket hinge 148. The first bracket hinge 146 comprises a first hinge lock 158, and the second bracket hinge 148 comprises a second hinge lock 150. The first hinge lock 158 and the second hinge lock 160 can be engaged to lock the secondary wheel bracket 144 in a secondary wheel deployed configuration 228 that is angled down and away from the load carrier frame 120.

The secondary wheel bracket 144, the first caster 154, the second caster 156, the first secondary wheel 150 and the second secondary wheel 152 can form a secondary wheel assembly 224. The secondary wheel assembly 224 is pivotally movable back and forth between a secondary wheel deployed configuration 228 and a secondary wheel stowed configuration 226. As shown in FIGS. 1-4B, 8B, and 9B, the plurality of secondary wheels 145 are disposed distal to the load carrier frame 120 in the secondary wheel deployed configuration 228. In the secondary wheel deployed configuration 228, the plurality of secondary wheels 145 can cooperate with the plurality of primary wheels 135 to support the load carrier frame 120 on at least four wheels. The secondary wheel assembly 224 pivots relative to the load carrier frame 120 on a first secondary wheel pivot pin 188 and a second secondary wheel pivot pin 190, each of which is operably connected to the load carrier frame 120.

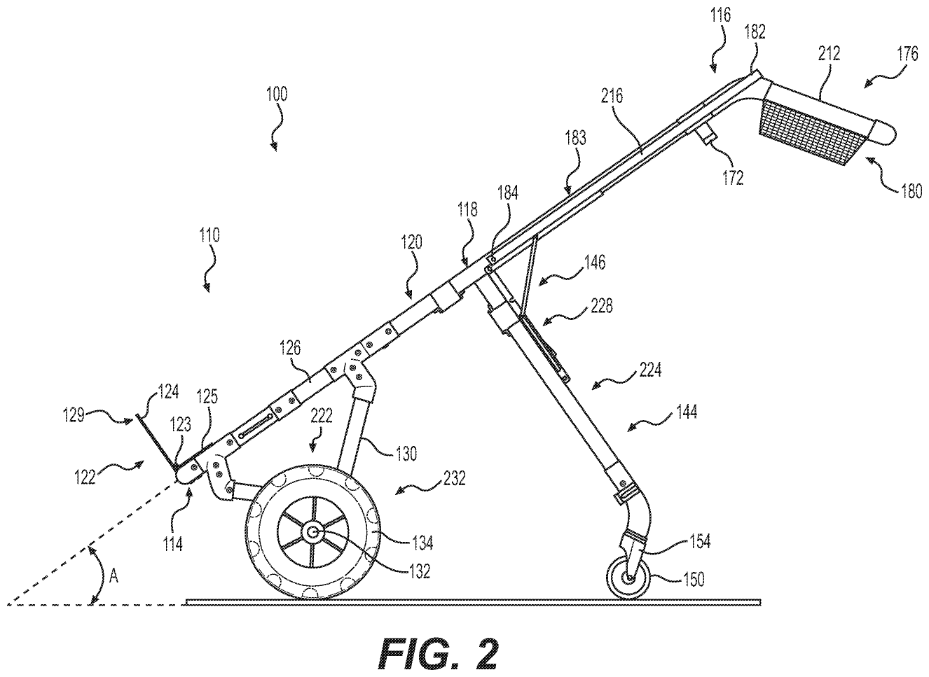

FIG. 2 illustrates angle A, which is the angle of alignment of the load carrier bed 118 relative to the surface upon which the hand truck 100 stands when the hand truck 100 is in the second hand truck operational configuration 110. As shown, angle A is approximately 35°.

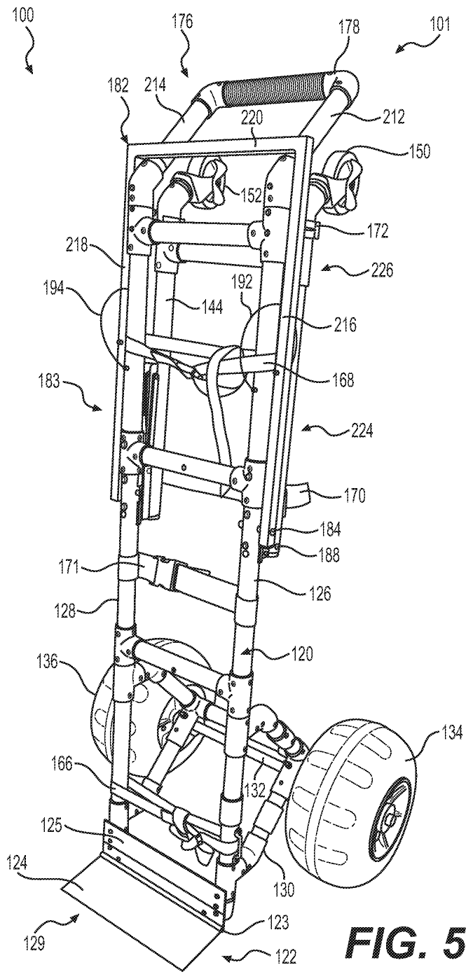

As shown in FIGS. 5, 6A, 7, 8A, and 9A, the secondary wheel assembly 224 is pivotable on the first and second wheel pivot pins 188 and 190 from the secondary wheel deployed configuration 228 to the secondary wheel stowed configuration 226 in which the plurality of secondary wheels 145 are aligned proximal to the load carrier frame 120. The secondary wheel assembly 224 is maintained in the secondary wheel stowed configuration 226 by a first secondary wheel bracket receiver 172 and a second secondary bracket receiver 174 engaging and retaining the secondary wheel bracket 144. The first secondary wheel bracket receiver 172 is attached to the first frame member 126, and the second secondary wheel bracket receiver 174 is attached to the second frame member 128.

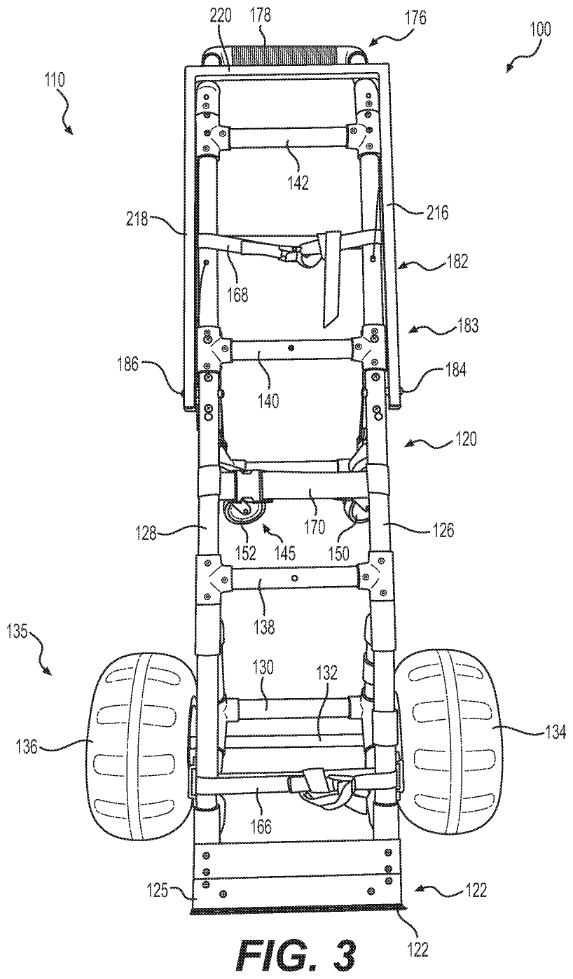

As shown in FIGS. 1 and 3, the hand truck 100 comprises a plurality of cargo fasteners in the form of a lower cargo strap 166 and an upper cargo strap 168. Each of the lower cargo strap 166 and the upper cargo strap 168 is attached to the load carrier frame 120 and is sized to extend around cargo and secure the cargo to the load carrier bed 118 when the hand truck 100 is in any of the hand truck operational configurations.

The handle 176 extends from the upper end 116 of the load carrier frame 120 and comprises a first handle side bar 212 and an opposing second handle side bar 214, both of which are connected to the load carrier frame 120. A handle cross bar 178 extends between and is connected to the first and second handle side bars 212 and 214. The hand truck 100 optionally can further comprise a basket 180, shown in FIG. 2, aligned proximal to the handle 176. In one aspect, the basket 180 can depend downward from the handle 176. The plurality of secondary wheels 145 are aligned proximal to the handle 176 in the secondary wheel stowed configuration 226.

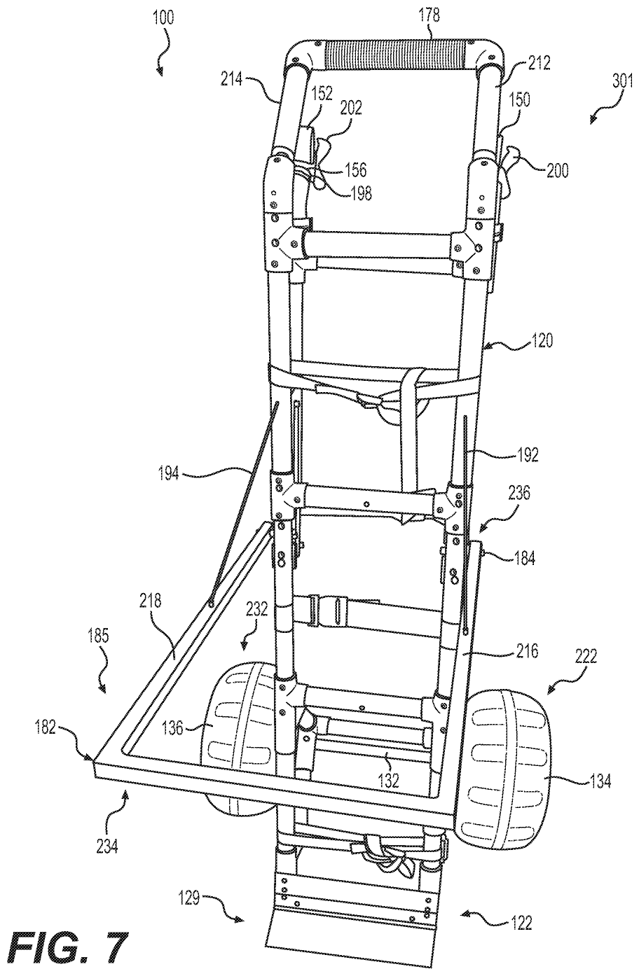

The hand truck 100 also comprises a cargo rack 182. As shown in FIGS. 1 and 7, the cargo rack 182 can be pivotally mounted to the load carrier frame 120. The cargo rack 182 comprises a first cargo rack arm 216 and an opposing second cargo rack arm 218. The first cargo rack arm 216 is pivotally mounted to the first frame member 126 by a first cargo rack pivot pin 184, and the second cargo rack arm 218 is pivotally mounted to the second frame member 128 by a second cargo rack pivot pin 186. The cargo rack 182 also can comprise a cargo rack cross bar 220 extending between and attached to the first and second cargo rack arms 216 and 218. As shown in FIGS. 5 and 7, a first cargo rack support cable 192 is connected to both the first cargo rack arm 216 and the first frame member 126, and a second cargo rack support cable 194 is connected to both the second cargo rack arm 218 and the second frame member 128. The first and second cargo rack support cables 192 and 194 support the cargo rack 182 in an angled alignment relative to the load carrier frame 120. The cargo rack 182 comprises a cargo rack base end 236 that is adjacent the points of attachment of the cargo rack 182 to the load carrier frame 120. The cargo rack 182 also comprises an outward end 234 that is in an opposing alignment with the cargo rack base end 236. The cargo rack outward end 234 is aligned proximal to the load carrier frame 120 in the cargo rack stowed configuration 183 and is aligned distal to the load carrier frame 120 in the cargo rack deployed configuration 185.

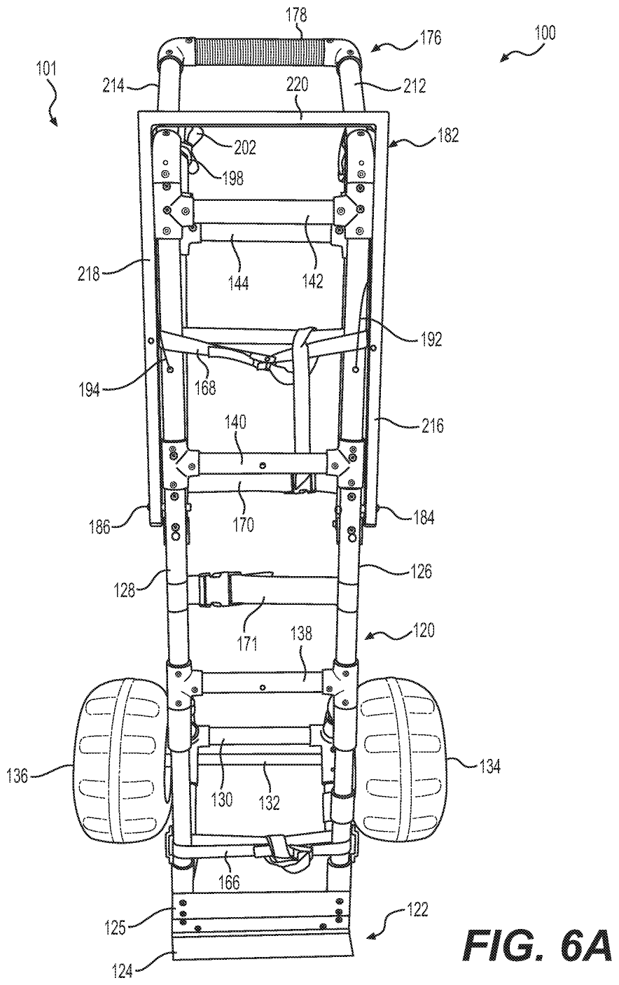

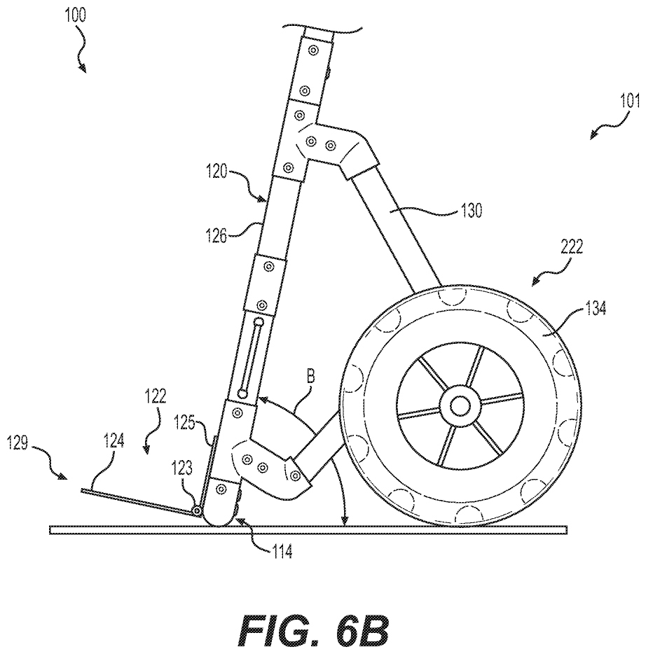

The cargo rack 182 can be reconfigured between the cargo rack stowed configuration 183, as shown in FIGS. 1 and 6A, and the cargo rack deployed configuration 185, as shown in FIG. 7. In the cargo rack stowed configuration 183, the cargo rack 182 is arranged in a generally closed alignment proximal to the load carrier frame 120. In the cargo rack stowed configuration 183, the first cargo rack arm 216 can be aligned generally parallel to the first frame member 126, and the second cargo rack arm 218 can be aligned generally parallel to the second frame member 128. The cargo rack cross bar 220 can be aligned proximal to the handle 176 and/or can be aligned generally perpendicular to the first and second frame members 126 and 128. In the cargo rack deployed configuration 185, the cargo rack 182 is arranged in a generally open alignment extending outward from and distal to the load carrier frame 120. In the cargo rack deployed configuration 185, the first cargo rack arm 216 can be aligned generally perpendicular to the first frame member 126, and the second cargo rack arm 218 can be aligned generally perpendicular to the second frame member 128. The cargo rack cross bar 220 can be aligned distal to the handle 176 and the first and second frame members 126 and 128. Alternatively, the first and second cargo rack arms 216 and 218 can be aligned at an acute angle relative to the first and second frame members 126 and 128, respectively, in the cargo rack deployed configuration 185.

FIG. 6B illustrates the base portion of the hand truck 100 in a generally upright alignment while in the first hand truck operational configuration 101, in which the hand truck 100 is supported by the plurality of primary wheels 135, but not the plurality of secondary wheels 145. In the generally upright alignment, the hand truck 100 is supported by the base end 114 of the load carrier frame 120 and the plurality of primary wheels 135. In the generally upright alignment, the load carrier frame 120 is aligned at an angle B of about 80° relative to the flat horizontal surface upon which the hand truck 100 is standing. In another aspect, the load carrier frame 120 can be aligned at an angle B in a range of approximately 60° to about 85° relative to the flat horizontal surface upon which the hand truck 100 is standing. In the generally upright alignment, the foot plate 124 of the base plate 122 is aligned proximal to the flat horizontal surface upon which the hand truck 100 is standing, but is angled relative thereto with at least a portion of the foot plate 124 not contacting the horizontal surface.

FIG. 7 illustrates the hand truck 100 in a third hand truck operational configuration 301. In the third hand truck operational configuration 301, the primary wheel assembly 222 is in the primary wheel deployed configuration 232, the secondary wheel assembly 224 is in the secondary wheel stowed configuration 226, and the cargo rack 182 is in the cargo rack deployed configuration 185. In the third hand truck operational configuration 301, the cargo rack 182 can be used to hang or mount one or more items of hanging cargo 260 on the hand truck 100.

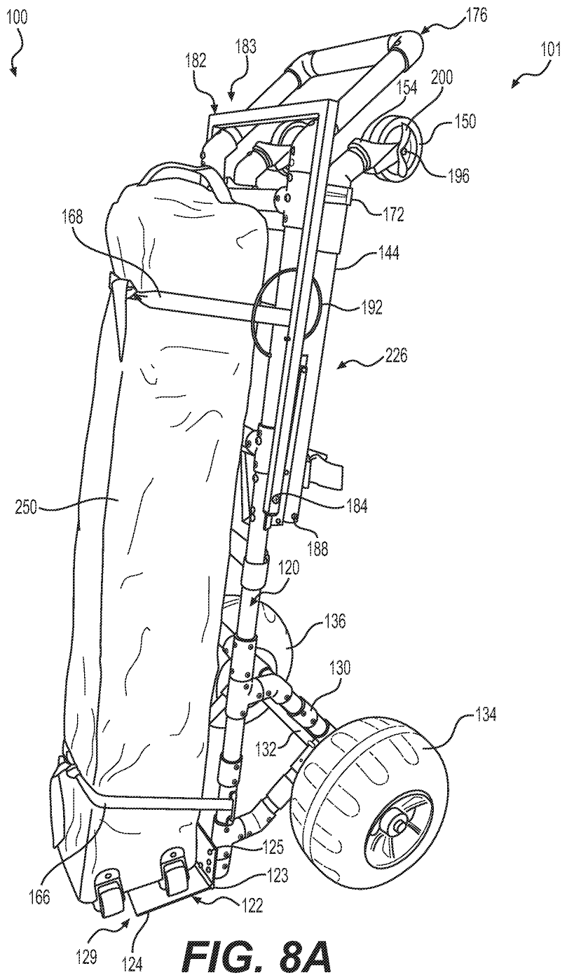

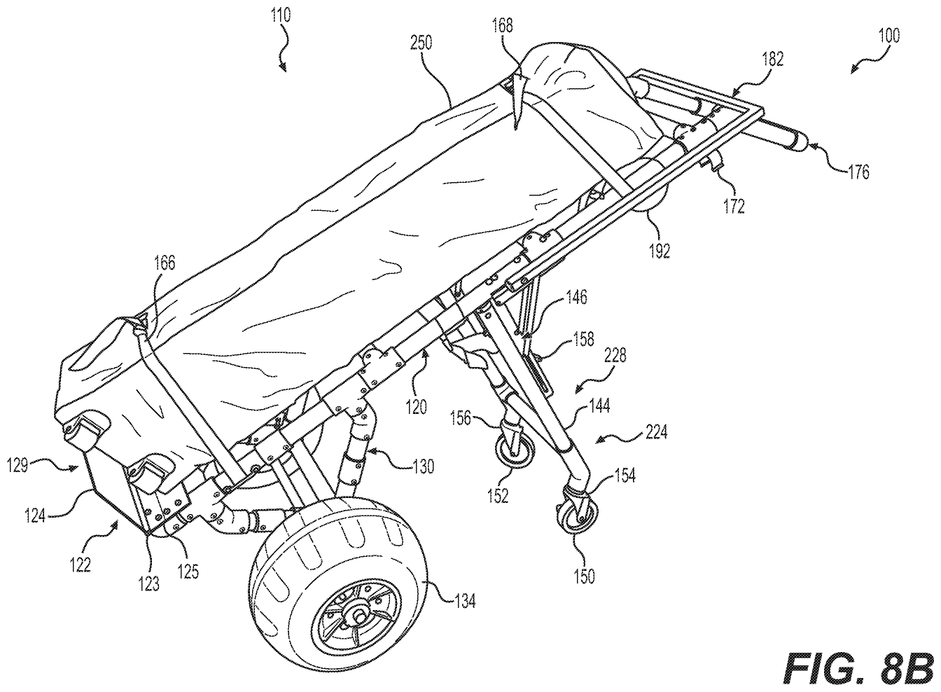

FIG. 8A illustrates the hand truck 100 in the first hand truck operational configuration 101 supporting cargo 250 disposed thereon. The cargo 250 is positioned on and supported by the base plate 122, with a portion of the cargo 250 contacting the foot plate 124 and aligned abutting the back plate 125. The cargo 250 is secured to the load carrier frame 120 by the lower cargo fastener 166 and the upper cargo fastener 168, both of which are illustrated as straps that extend around and are secured circumferentially to the cargo 250. The cargo 250 contacts at least a portion of the load carrier bed 118, including the lower cross bar 138 and the middle cross bar 140. To move the hand truck 100 loaded with the cargo 250 while in the first hand truck operational configuration 101, a user can hold the handle 176 and lean the hand truck 100 back so that the base end 114 of the load carrier frame 120 is lifted upward off the surface upon which the hand truck 100 stands, thereby resulting in the load carrier frame 120 being aligned at a more acute angle relative to the supporting surface, and the plurality of primary wheels 135 being the only component supports for the hand truck 100. The secondary wheel assembly 224 is aligned in the secondary wheel stowed configuration 226 with the secondary wheel bracket 144 secured in a stowed position by the engagement of the first and second secondary wheel receivers 172 and 174 therewith.

FIG. 8B illustrates the hand truck 100 in the second hand truck operational configuration 110 supporting cargo 250 secured thereto. The secondary wheel assembly 224 is aligned in the secondary wheel deployed configuration 228, with the plurality of secondary wheels 145 aligned on the surface on which the plurality of primary wheels 135 are disposed, thereby allowing the load carrier frame 120 to be supported by both the plurality of primary wheels 135 and the plurality of secondary wheels 145. The cargo is supported by the foot plate 124, the back plate 125 and the load carrier frame 120 in an angled, reclined alignment. The weight of the cargo is distributed to and born by both the plurality of primary wheels 135 and the plurality of secondary wheels 145. The distribution of the combined weights of both the hand truck 100 and the cargo 250 to the plurality of primary wheels 135 and the plurality of secondary wheels 145 thereby allows a user to push or pull the loaded hand truck 100 by the handle 176 so that the loaded hand truck 100 can move on the rolling plurality of primary wheels 135 and the rolling plurality of secondary wheels 145.

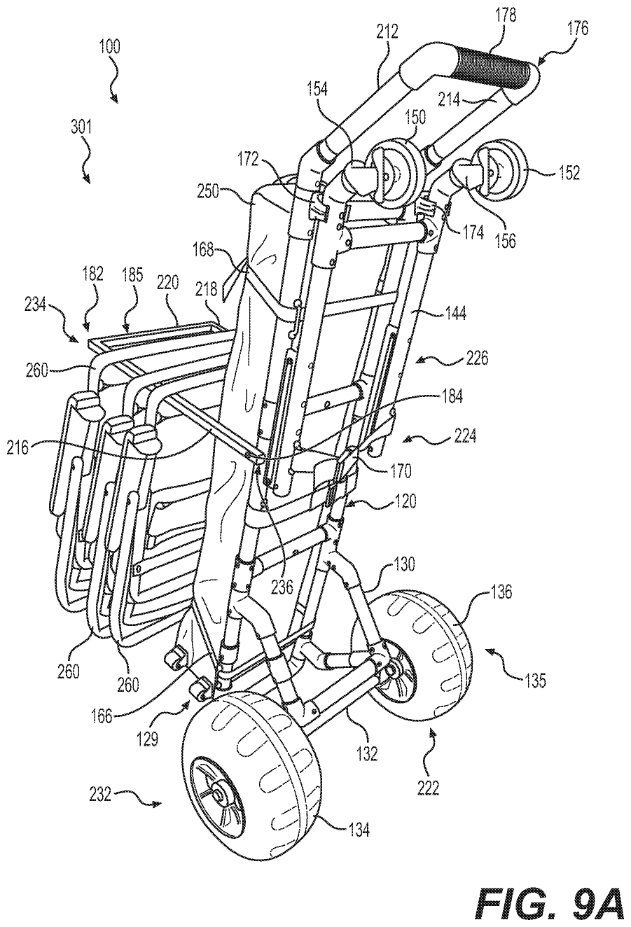

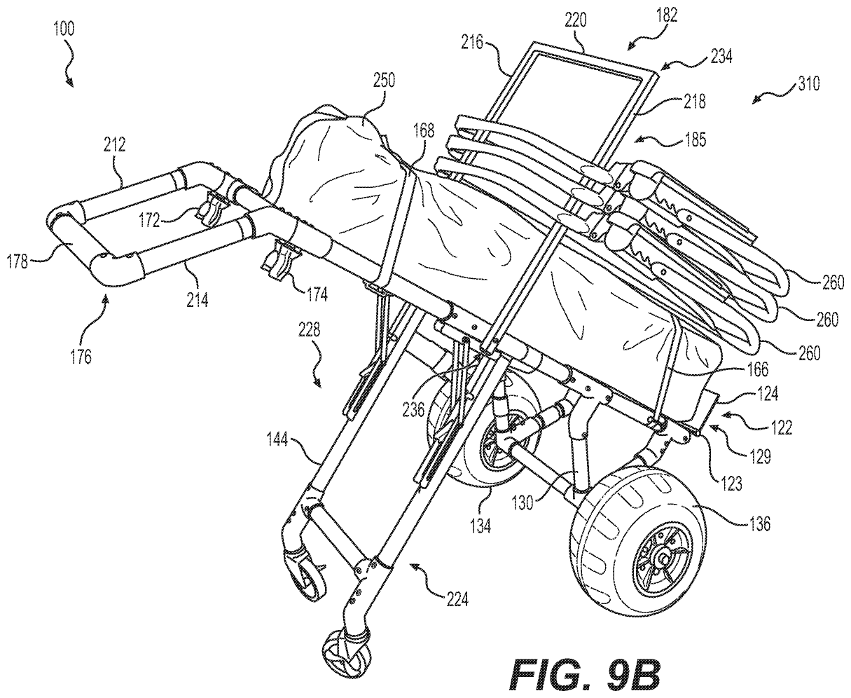

FIG. 9A illustrates the hand truck 100, loaded with both cargo 250 and hanging cargo 260, in the third hand truck operational configuration 301, with the primary wheel assembly 222 in the primary wheel deployed configuration 232, the secondary wheel assembly 224 in the secondary wheel stowed configuration 226, and the cargo rack 182 in the cargo rack deployed configuration 185. Hanging cargo 260, illustrated as a plurality of folding chairs in FIGS. 9A and 9B, is hung from the cargo rack 182, and cargo 250, illustrated as a folded and packaged beach tent, is secured to the load carrier bed 118 by the lower cargo fastener 166 and the upper cargo fastener 168. The loaded hand truck 100 is in a generally upright alignment for standing in place. A user can pull back and down on the handle 176 to realign the load carrier frame 120 on the plurality of primary wheels 135 to a reclined alignment for moving of the hand truck 100 from one location to another.

FIG. 9B illustrates the hand truck 100 loaded with both cargo 250 and hanging cargo 260, in a forth operational configuration 310. In the fourth hand truck operational configuration 310, the primary wheel assembly 222 is in the primary wheel deployed configuration 232, the secondary wheel assembly 224 is in the secondary wheel deployed configuration 228, and the cargo rack 182 is in the cargo rack deployed configuration 185. A user can reconfigure the hand truck 100 to the fourth hand truck operational configuration 310 so as to support the hand truck 100 on a multi-wheeled base comprising both the plurality of primary wheels 135 and the plurality of secondary wheels 145. The angle of alignment of the cargo rack 182 in the cargo rack deployed configuration 185 is approximately equal to the angle of alignment of the legs of the secondary wheel bracket 144 in the secondary wheel deployed configuration 228. Rather than hanging freely on the cargo rack 182, the hanging cargo 260 is stacked on the cargo 250 and the cargo rack 182.

FIGS. 11 and 12 illustrate the hand truck 100 in a hand truck stowed configuration 410 for storage and/or transportation of the hand truck 100 when unloaded and not in use. In the hand truck stowed configuration 410, the primary wheel assembly 222 is in a primary wheel stowed configuration 230, the secondary wheel assembly 224 is in the secondary wheel stowed configuration 226, the cargo rack 182 is in the cargo rack stowed configuration 183, and the base plate 122 is in a base plate stowed configuration 127. In the primary wheel stowed configuration 230, the primary wheel assembly 222 is disengaged from the first primary wheel axle receiver 208 and the second primary wheel axle receiver 210 and is detached from the primary wheel bracket 130 and, instead, is secured to the load carrier frame 120 by a first primary wheel fastener 170 and a second primary wheel fastener 171, both of which are illustrated as straps attached to the load carrier frame 120. The primary wheel assembly 222 is positioned on the rear side of the load carrier bed 118 between the handle 176 and the primary wheel bracket 130. In the base plate stowed configuration 127, the foot plate 124 is pivoted on the base plate hinge 123 from on open alignment to a closed alignment proximal to and/or contacting the back plate 125. In the hand truck stowed configuration 410, the hand truck 100 can be positioned with the front of the load carrier bed 118 facing down. Alternatively, the hand truck 100 can be stowed on a hanging rack by placing one of the cross bars on a hanging rack.

The hand truck 100 is reconfigurable between the multiple hand truck operational configurations. In the first hand truck operational configuration 101, shown in FIGS. 5, 6A and 6B, only the plurality of primary wheels 135 are configured to support the hand truck 100 and allow it to roll thereon. In the first hand truck operational configuration 101, the plurality of primary wheels 135 are in a primary wheel deployed configuration 232 in which the primary wheel axle 132 is engaged with the first primary wheel axle receiver 208 and the second primary wheel axle receiver 210, thereby mounting the primary wheel assembly 222 to the primary wheel bracket 130 so as to align the first primary wheel 134 and the second primary wheel 136 rearward and to either side of the load carrier bed 118. In the first hand truck operational configuration 101, the secondary wheel assembly 224 is in a secondary wheel stowed configuration 226 in which the plurality of secondary wheels 145 are not aligned to support the hand truck 100. The foot plate 122, in a first hand truck operational configuration 101, is in a base plate deployed configuration 129 in which the foot plate 122 is rotated on the base plate hinge 123 at an angle relative to the back plate 125. The cargo rack 182 is in the cargo rack stowed configuration 183 in the first hand truck operational configuration 101. In the first hand truck operational configuration 101, the hand truck 101 can stand in a generally upright alignment on the plurality of wheels 135 and the foot plate 124 of the base plate 122. The hand truck 100 can be adjusted back and forth between the generally upright alignment and a reclined alignment by adjusting the load carrier frame 120 relative to the plurality of primary wheels 135 by manually moving the handle 176. When in the first hand truck operational configuration 101, the hand truck 100 can be manually adjusted to place the load carrier frame 120 in a reclined alignment to move the hand truck 100 from a first to a second location.

The hand truck 100 is reconfigurable back and forth between the first hand truck operational configuration 101 and the second hand truck operational configuration 110, shown in FIGS. 1, 2, 3, 4A, and 4B. In the second hand truck operational configuration 110, the primary wheel assembly 222 is in the primary wheel deployed configuration 232, the foot plate 122 is in the base plate deployed configuration 129, and the cargo rack 182 is in the cargo rack stowed configuration 183. Unlike the first hand truck operational configuration 101, in the second hand truck operational configuration 110, the secondary wheel assembly 224 is in the secondary wheel deployed configuration 228 in which the plurality of secondary wheels 145 is aligned distal to the load carrier bed 118 and is aligned to support the hand truck 100 in cooperation with the plurality of primary wheels 135. The secondary wheel assembly 224 is disengaged from the first and second secondary wheel receivers 172 and 174 to move the secondary wheel assembly 224 from the secondary wheel stowed configuration 226 to the secondary wheel deployed configuration 228. In the second hand truck operational configuration 110, the load carrier frame 120 is in a reclined alignment in which the hand truck 100 is self supported on both the plurality of primary wheels 135 and the plurality of secondary wheels 145.

The hand truck 100 also is reconfigurable back and forth between any of the first hand truck operational configuration 101, the second hand truck operational configuration 110, and a third hand truck operational configuration 301. In the third hand truck operational configuration 301, shown in FIGS. 7 and 9A, the primary wheel assembly 222 is aligned in the primary wheel deployed configuration 232, the secondary wheel assembly 224 is aligned in the secondary wheel stowed configuration 226, the foot plate 122 is in a base plate deployed configuration 129, and the cargo rack 182 is in a cargo rack deployed configuration 185 in which the cargo rack 182 is pivoted away from the load carrier bed 118 to form an angle therewith. As in the first hand truck operational configuration 101, the plurality of primary wheels 135 are the only wheels upon which the hand truck 100 is supported and roll. The cargo rack 182 can receive hanging cargo 260 thereon, or have other cargo 250 disposed against or adjacent thereto.

The hand truck 100 also is reconfigurable back and forth between any of the first hand truck operational configuration 101, the second hand truck operational configuration 110, the third hand truck operational configuration 301, and a fourth hand truck operational configuration 310. In the fourth hand truck operational configuration 310, shown in FIG. 9B, the primary wheel assembly 222 is aligned in the primary wheel deployed configuration 232, the secondary wheel assembly 224 is aligned in the secondary wheel deployed configuration 228, the foot plate 122 is in the base plate deployed configuration 129, and the cargo rack 182 is in a cargo rack deployed configuration 185. As in the second hand truck operational configuration 110, the hand truck 100 is supported by and can roll on both the plurality of primary wheels 135 and the plurality of secondary wheels 145. In the fourth hand truck operational configuration 310, each of the cargo rack 182 and the secondary wheel assembly 224 can form an angle with the load carrier bed 118. In one aspect, each of the cargo rack 182 and the secondary wheel assembly 224 can form an angle of about 90° with the load carrier bed 118 with the cargo rack 182 extending from the front of the load carrier bed 118 and the secondary wheel assembly 224 extending from the rear of the load carrier bed 118.

Additionally, the hand truck 100 is reconfigurable back and forth between any of the first hand truck operational configuration 101, the second hand truck operational configuration 110, the third hand truck operational configuration 301, the fourth hand truck operational configuration 310, and the hand truck stowed configuration 410, shown in FIGS. 11 and 12. In the hand truck stowed configuration 410, the primary wheel assembly 222 is in the primary wheel stowed configuration 230, the secondary wheel assembly 224 is in the secondary wheel stowed configuration 226, the cargo rack 182 is in the cargo rack stowed configuration 183, and the foot plate 124 is in the base plate stowed configuration 127. In the hand truck stowed configuration 410, the hand truck 100 is not configured to be supported by and roll on any of the plurality of primary wheels 135 or the plurality of secondary wheels 145.

Encompassed by the present disclosure is a hand truck 100 having a load carrier bed 118 that is approximately 135 cm in length from the base end 114 to the upper end 116 and approximately 13 cm in width. The handle 176 is approximately 28 cm in length and is angled relative to the load carrier bed 118 at an angle of approximately 45° measured from the bottom of the handle to the back of the load carrier bed 118. Each of the first cargo rack arm 216 and the second cargo rack arm 218 has a length of approximately 63.5 cm and is pivotal along a 90° arc from the cargo rack stowed configuration 183 to the cargo rack deployed configuration 185.

The cargo rack 182 is aligned at an angle of approximately 90° relative to the first frame member 126 in the cargo rack deployed configuration 185. The foot plate 122 is approximately 33 cm wide and approximately 20 cm in length from front to back. The foot plate 122 is pivotal along a 90° arc from the base plate stowed configuration 127 to the base plate deployed configuration 129. The foot plate 122 is aligned at an angle of approximately 90° relative to the back plate 125 in the base plate deployed configuration 129.

The secondary wheel bracket 144 also is pivotal along a 90° arc from the secondary wheel stowed configuration 226 to the secondary wheel deployed configuration 228. The secondary wheel bracket 144 is aligned at an angle of approximately 90° relative to the first frame member 126 in the secondary wheel deployed configuration 228. The secondary wheel bracket 144 comprises a first and a second bracket leg, each of which is approximately 58.4 cm in length. Depending, respectively, from the first and second bracket legs are a first and second bracket foot, each of which is approximately 5 cm in length. Each of the first and second bracket feet are aligned at an angle of approximately 55° relative to the respective first and second bracket legs. From the first and second bracket feet depend first and second casters 154 and 156, respectively. The first and second casters 154 and 156 can swivel 360° and comprise first and second secondary wheels 150 and 152, respectively, each of which has a diameter of approximately 10 cm. In the second hand truck operational configuration 110, the angle formed by the load carrier bed 118 with a flat surface upon which the hand truck 100 stands is approximately 35°. The handle 176 is disposed approximately 96.5 cm above the flat surface upon which the hand truck 100 stands in the second hand truck operational configuration 110.

The primary wheel axle 132 is offset from the bottom edge of the load carrier bed 118 approximately 33 cm and aligned rearward of the load carrier bed 118 approximately 29 cm. Each of the first primary wheel 136 and the second primary wheel 136 has a diameter of approximately 30.5 cm and a width of approximately 18 cm. In the first hand truck operational configuration 101, the angle formed by the load carrier bed 118 with a flat surface upon which the hand truck 100 stands is approximately 80°.

It will be apparent to those skilled in the art that various modifications and variations can be made to the hand trucks set forth herein and such modifications and variations are contemplated and encompassed by the present disclosure.

What is claimed is:

1. A hand truck comprising:
a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end;
a handle connected to the load carrier frame and aligned proximal to the upper end of the load carrier frame and distal to the base end of the lower carrier frame;
a primary wheel assembly detachably connected to the load carrier frame, wherein the primary wheel assembly comprises primary wheel axle and a plurality of primary wheels rotatably mounted on the primary wheel axle, wherein the primary wheel assembly is reconfigurable between a primary wheel deployed configuration and a primary wheel stowed configuration, wherein the primary wheel assembly is connected to the primary wheel bracket and configured to rotatably support the load carrier frame in the primary wheel deployed configuration, wherein the plurality of primary wheels are aligned distal to the load carrier bed in the primary wheel deployed configuration, wherein the primary wheel assembly is connected to the load carrier bed in the primary wheel stowed configuration, and wherein the plurality of wheels are aligned proximal to the load carrier bed in the primary wheel stowed configuration;
a secondary wheel assembly movably connected to the load carrier frame, wherein the secondary wheel assembly comprises a secondary wheel bracket and a plurality of secondary wheels rotatably mounted on the secondary wheel bracket, wherein the secondary wheel assembly is reconfigurable between a secondary wheel deployed configuration and a secondary wheel stowed configuration, wherein the plurality of secondary wheels are aligned distal to the load carrier bed in the secondary wheel deployed configuration, and wherein the plurality of secondary wheels are aligned proximal to the load carrier bed in the secondary wheel stowed configuration;
wherein the hand truck is reconfigurable between a first hand truck operational configuration, a second hand truck operational configuration, and a hand truck stowed configuration, wherein the hand truck is configured to roll and to support cargo in the first hand truck operational configuration and the second hand truck operational configuration, wherein the hand truck is configured for unloaded storage and transport in the hand truck stowed configuration, wherein the primary wheel assembly is in the primary wheel deployed configuration and the secondary wheel assembly is in the secondary wheel stowed configuration in the first hand truck operational configuration, wherein the primary wheel assembly is in the primary wheel deployed configuration and the secondary wheel assembly is in the secondary wheel deployed configuration in the second hand truck operational configuration, and wherein the primary wheel assembly is in the primary wheel stowed configuration and the secondary wheel assembly is in the secondary wheel stowed configuration in the hand truck stowed configuration.

2. The hand truck of claim 1, further comprising a primary wheel assembly receiver mounted on the primary wheel bracket, wherein the primary wheel assembly receiver engages the primary wheel axle of the primary wheel assembly in the primary wheel deployed configuration, and wherein the primary wheel assembly is disengaged from the primary wheel assembly receiver in the primary wheel stowed configuration.

3. The hand truck of claim 1, further comprising a primary wheel fastener connected to the load carrier bed, wherein the primary wheel fastener connects the primary wheel assembly to the load carrier bed in the primary wheel stowed configuration.

4. The hand truck of claim 1, further comprising a base plate mounted to the load carrier frame proximal to the base end and distal to the upper end of the load carrier frame, wherein the base plate is configured to receive cargo loaded on the hand truck, wherein the base plate comprises a back plate connected to the load carrier bed, a base plate hinge mounted to the back plate, and a foot plate connected to the base plate hinge, wherein the foot plate is pivotal on the base plate hinge between a base plate deployed configuration and a base plate stowed configuration, wherein the foot plate is aligned distal to the back plate in the base plate deployed configuration, wherein the foot plate is aligned proximal to the back plate in the base plate stowed configuration, and wherein the foot plate is in the base plate stowed configuration in the hand truck stowed configuration.

5. The hand truck of claim 1, wherein each primary wheel of the plurality of primary wheels exhibits a width that is in a range of about 50% to about 120% of the diameter of the primary wheel.

6. The hand truck of claim 1, further comprising a cargo rack movably mounted to the load carrier frame, and wherein the cargo rack comprises a cargo rack outward side and a cargo rack base side.

7. The hand truck of claim 6, wherein the cargo rack is movable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration.

8. The hand truck of claim 7, wherein the hand truck is reconfigurable between the first hand truck operational configuration, the second hand truck operational configuration, a third hand truck operational configuration, a fourth hand truck operational configuration, and the hand truck stowed configuration, wherein the hand truck is configured to roll and support cargo in the third hand truck operational configuration and the fourth hand truck operational configuration, wherein the primary wheel assembly is in the primary wheel deployed configuration in the third hand truck operational configuration, wherein the secondary wheel assembly is in the secondary wheel stowed configuration in the third hand truck operational configuration, wherein the cargo rack is in the cargo rack deployed configuration in the third hand truck operational configuration, wherein the primary wheel assembly is in the primary wheel deployed configuration in the fourth hand truck operational configuration, wherein the secondary wheel assembly is in the secondary wheel deployed configuration in the fourth hand truck operational configuration, and wherein the cargo rack is in the cargo rack deployed configuration in the fourth hand truck operational configuration.

9. A hand truck comprising:
a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end;
a handle connected to the load carrier frame and aligned proximal to the upper end of the load carrier frame and distal to the base end of the lower carrier frame;
a cargo rack pivotally mounted to the load carrier frame, wherein the cargo rack comprises a cargo rack outward side and a cargo rack base side, wherein the cargo rack is pivotable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration;
a primary wheel assembly detachably connected to the load carrier frame, wherein the primary wheel assembly comprises primary wheel axle and a plurality of primary wheels rotatably mounted on the primary wheel axle, wherein the primary wheel assembly is movable between a primary wheel deployed configuration and a primary wheel stowed configuration, and wherein the plurality of primary wheels are configured to roll and to support the load carrier frame in the primary wheel deployed configuration;
a secondary wheel assembly pivotally connected to the load carrier frame, wherein the secondary wheel assembly comprises a secondary wheel bracket and a plurality of secondary wheels rotatably mounted to the secondary wheel bracket, wherein the secondary wheel assembly is pivotable between a secondary wheel deployed configuration and a secondary wheel stowed configuration, and wherein the plurality of secondary wheels are configured to roll and to support the load carrier frame in the secondary wheel deployed configuration;
wherein the hand truck is reconfigurable between a first hand truck operational configuration, a second hand truck operational configuration, a third hand truck operational configuration, a fourth hand truck operational configuration, and a hand truck stowed configuration, wherein the hand truck is configured to roll and to support cargo in the first hand truck operational configuration, the second hand truck operational configuration, the third hand truck operational configuration, and the fourth hand truck operational configuration, wherein the hand truck is configured for unloaded storage and transport of the hand truck in the hand truck stowed configuration, wherein the primary wheel assembly is in the primary wheel deployed configuration in the first hand truck operational configuration, the secondary wheel assembly is in the secondary wheel stowed configuration in the first hand truck operational configuration, the cargo rack is in the cargo rack stowed configuration in the first hand truck operational configuration, wherein the primary wheel assembly is in the primary wheel deployed configuration in the second hand truck operational configuration, the secondary wheel assembly is in the secondary wheel deployed configuration in the second hand truck operational configuration, the cargo rack is in the cargo rack stowed configuration in the second hand truck operational configuration, wherein the primary wheel assembly is in the primary wheel deployed configuration in the third hand truck operational configuration, the secondary wheel assembly is in the secondary wheel stowed configuration in the third hand truck operational configuration, the cargo rack is in the cargo rack deployed configuration in the third hand truck operational configuration, wherein the primary wheel assembly is in the primary wheel deployed configuration in the fourth hand truck operational configuration, the secondary wheel assembly is in the secondary wheel deployed configuration in the fourth hand truck operational configuration, the cargo rack is in the cargo rack deployed configuration in the fourth hand truck operational configuration, wherein the primary wheel assembly is in the primary wheel stowed configuration in the hand truck stowed configuration, the secondary wheel assembly is in the secondary wheel stowed configuration in the hand truck stowed configuration, and the cargo rack is in the cargo rack stowed configuration in the hand truck stowed configuration.

10. The hand truck of claim 9, further comprising a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, wherein the foot plate is aligned proximal to the back plate in the base plate stowed configuration, and wherein the foot plate is in the base plate stowed configuration in the hand truck stowed configuration.

11. The hand truck of claim 9, wherein each primary wheel of the plurality of primary wheels exhibits a width that is in range of about 50% to about 120% of the diameter of the primary wheel.

12. The hand truck of claim 9, further comprising a primary wheel fastener connected to the load carrier bed, wherein the primary wheel fastener connects the primary wheel assembly to the load carrier bed in the primary wheel stowed configuration.

13. The hand truck of claim 9, wherein the cargo rack comprises a first cargo rack arm, an opposing second cargo rack arm, and a cargo rack cross bar extending between and connected to the first cargo rack arm and the second cargo rack arm.

14. A hand truck comprising:
a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end;
a handle connected to the load carrier frame and aligned proximal to the upper end of the load carrier frame and distal to the base end of the lower carrier frame;
a cargo rack pivotally mounted to the load carrier frame, wherein the cargo rack comprises a cargo rack outward side and a cargo rack base side, wherein the cargo rack is pivotable between a cargo rack deployed configuration and a cargo rack stowed configuration, wherein the cargo rack outward side is aligned distal to the load carrier bed in the cargo rack deployed configuration, and wherein the cargo rack outward side is aligned proximal to the load carrier bed in the cargo rack stowed configuration, wherein the cargo rack further comprises a first cargo rack arm, an opposing second cargo rack arm, and a cargo rack cross bar extending between and connected to the first cargo rack arm and the second cargo rack arm;
a primary wheel assembly detachably connected to the load carrier frame, wherein the primary wheel assembly comprises primary wheel axle and a plurality of primary wheels rotatably mounted on the primary wheel axle, wherein the primary wheel assembly is movable between a primary wheel deployed configuration and a primary wheel stowed configuration, wherein the plurality of primary wheels are configured to roll and to support the load carrier frame in the primary wheel deployed configuration, wherein the primary wheel assembly is connected to the primary wheel bracket in the primary wheel deployed configuration and disconnected from the primary wheel bracket in the primary wheel stowed configuration, wherein each primary wheel of the plurality of primary wheels exhibits a width that is in a range of 50% to 120% of a diameter of the primary wheel;
a secondary wheel assembly pivotally connected to the load carrier frame, wherein the secondary wheel assembly comprises a secondary wheel bracket and a plurality of secondary wheels rotatably mounted to the secondary wheel bracket, wherein the secondary wheel assembly is pivotable between a secondary wheel deployed configuration and a secondary wheel stowed configuration, and wherein the plurality of secondary wheels are configured to roll and to support the load carrier frame in the secondary wheel deployed configuration;
wherein the hand truck is reconfigurable between a first hand truck operational configuration, a second hand truck operational configuration, a third hand truck operational configuration, a fourth hand truck operational configuration, and a hand truck stowed configuration, wherein the hand truck is configured to roll and to support cargo in the first hand truck operational configuration, the second hand truck operational configuration, the third hand truck operational configuration, and the fourth hand truck operational configuration, wherein the hand truck is configured for unloaded storage and transport of the hand truck in the hand truck stowed configuration, wherein the primary wheel assembly is in the primary wheel deployed configuration in the first hand truck operational configuration, the secondary wheel assembly is in the secondary wheel stowed configuration in the first hand truck operational configuration, the cargo rack is in the cargo rack stowed configuration in the first hand truck operational configuration, wherein the primary wheel assembly is in the primary wheel deployed configuration in the second hand truck operational configuration, the secondary wheel assembly is in the secondary wheel deployed configuration in the second hand truck operational configuration, the cargo rack is in the cargo rack stowed configuration in the second hand truck operational configuration, wherein the primary wheel assembly is in the primary wheel deployed configuration in the third hand truck operational configuration, the secondary wheel assembly is in the secondary wheel stowed configuration in the third hand truck operational configuration, the cargo rack is in the cargo rack deployed configuration in the third hand truck operational configuration, wherein the primary wheel assembly is in the primary wheel deployed configuration in the fourth hand truck operational configuration, the secondary wheel assembly is in the secondary wheel deployed configuration in the fourth hand truck operational configuration, the cargo rack is in the cargo rack deployed configuration in the fourth hand truck operational configuration, wherein the primary wheel assembly is in the primary wheel stowed configuration in the hand truck stowed configuration, the secondary wheel assembly is in the secondary wheel stowed configuration in the hand truck stowed configuration, and the cargo rack is in the cargo rack stowed configuration in the hand truck stowed configuration.

15. The hand truck of claim 14, further comprising a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, and wherein the foot plate is aligned proximal to the back plate in the base plate stowed configuration.

16. A hand truck comprising:
a load carrier frame comprising a load carrier bed and a primary wheel bracket connected to the load carrier bed, wherein the load carrier frame comprises an upper end and a base end, wherein the primary wheel bracket is disposed proximal to the base end and distal to the upper end;
a handle connected to the load carrier frame and aligned proximal to the upper end of the load carrier frame and distal to the base end of the lower carrier frame;
a primary wheel assembly detachably connected to the load carrier frame, wherein the primary wheel assembly comprises primary wheel axle and a plurality of primary wheels rotatably mounted on the primary wheel axle, wherein each primary wheel of the plurality of primary wheels exhibits a width in a range of about 50% to about 120% of the diameter of the primary wheel, wherein the primary wheel assembly is reconfigurable between a primary wheel deployed configuration and a primary wheel stowed configuration, wherein the primary wheel assembly is connected to the primary wheel bracket and configured to rotatably support the load carrier frame in the primary wheel deployed configuration, wherein the plurality of primary wheels are aligned distal to the load carrier bed in the primary wheel deployed configuration, wherein the primary wheel assembly is connected to the load carrier bed in the primary wheel stowed configuration, and wherein the plurality of wheels are aligned proximal to the load carrier bed in the primary wheel stowed configuration;
wherein the hand truck is reconfigurable between a hand truck operational configuration and a hand truck stowed configuration, wherein the hand truck is configured to roll and to support cargo in the hand truck operational configuration, wherein the hand truck is configured for unloaded storage and transport in the hand truck stowed configuration, wherein the primary wheel assembly is in the primary wheel deployed configuration in the hand truck operational configuration, and wherein the primary wheel assembly is in the primary wheel stowed configuration in the hand truck stowed configuration.

17. The hand truck of claim 16, further comprising a primary wheel assembly receiver mounted to the primary wheel bracket, wherein the primary wheel assembly receiver engages the primary wheel assembly in the primary wheel deployed configuration, and wherein the primary wheel assembly is disengaged from the primary wheel assembly receiver in the primary wheel stowed configuration.

18. The hand truck of claim 16, further comprising a cargo rack movably mounted to the load carrier frame, and wherein the cargo rack comprises a cargo rack outward side and a cargo rack base side.

19. The hand truck of claim 18, wherein the cargo rack is movable between a cargo rack deployed configuration and a cargo rack stowed configuration, wherein the cargo rack outward side is aligned distal to the load carrier bed in the cargo rack deployed configuration, wherein the cargo rack outward side is aligned proximal to the load carrier bed in the cargo rack stowed configuration, wherein the cargo rack is aligned in the cargo rack stowed configuration in the hand truck stowed configuration.

20. The hand truck of claim 16, further comprising a base plate mounted to the load carrier frame proximal to the base end and distal to the upper end of the load carrier frame, wherein the base plate comprises a back plate connected to the load carrier frame, a base plate hinge mounted to the back plate, and a foot plate connected to the base plate hinge, wherein the foot plate is pivotal between a base plate deployed configuration and a base plate stowed configuration, wherein the foot plate is aligned distal to the back plate in the base plate deployed configuration, wherein the foot plate is aligned proximal to the back plate in the base plate stowed configuration, and wherein the foot plate is in the base plate stowed configuration in the hand truck stowed configuration.
